(19) United States
(12) Patent Application Publication
(10) Pub. No.: US 2009/0049470 A1
(43) Pub. Date: Feb. 19, 2009

(54) Method and device for interactive operation of television

(76) Inventors: Gal Peer, Haifa (IL); Uzi Ezra Havosha, Tel Aviv (IL)

Correspondence Address: UZI EZRA HAVOSHA & PARTNERS, HADAR-DAFNA HOUSE 39 SHAOUL HAMELECH STREET, TEL AVIV, 64928, IL

(21) Appl. No.: 11/891,562

(22) Filed: Aug. 13, 2007

(51) Int. Cl. G06F 3/00

(52) U.S. Cl. 725/38; 345/158; 345/27; 725/61

(57) ABSTRACT

Image processing or image analysis to produce real time effects on images on a screen. The user shoots an imaginary gun, points a wooden stick, points his finger that has a colored paper attached etc, at the screen and effects happen to the images on the screen. The effects could be bullet holes, arrows, clothes, a raw egg, dripping blood, band-aids, etc. The effects move with the image on the screen as if the effect was really physically on the body. When the image leaves the screen temporarily and returns, the effect could still be in place on the image and move with the image. The identifying camera could be on the gun, stick and the like facing the images on the screen or the identifying camera could be on the screen of the TV, computer and the like facing the user with his stick or colored finger.

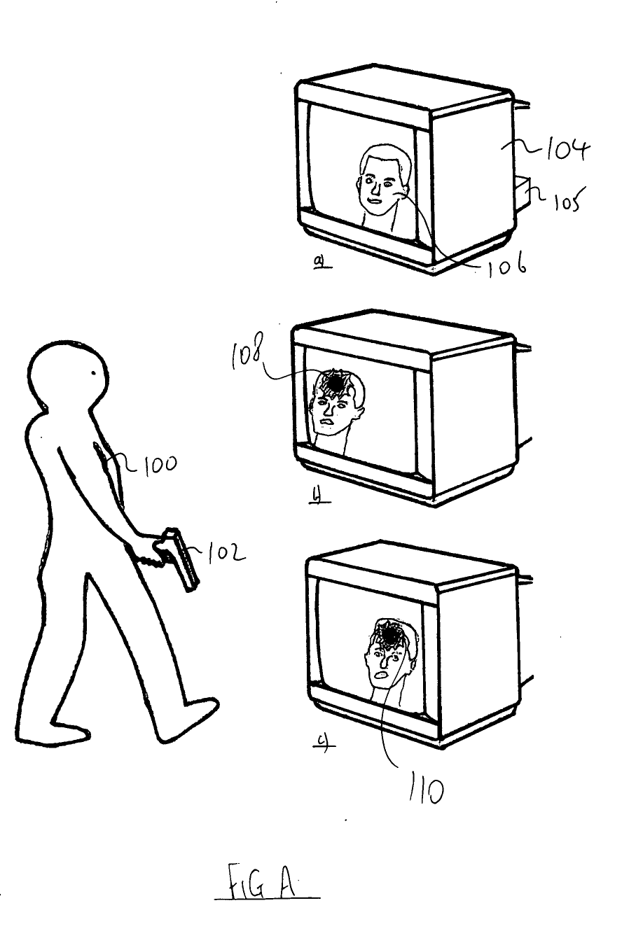

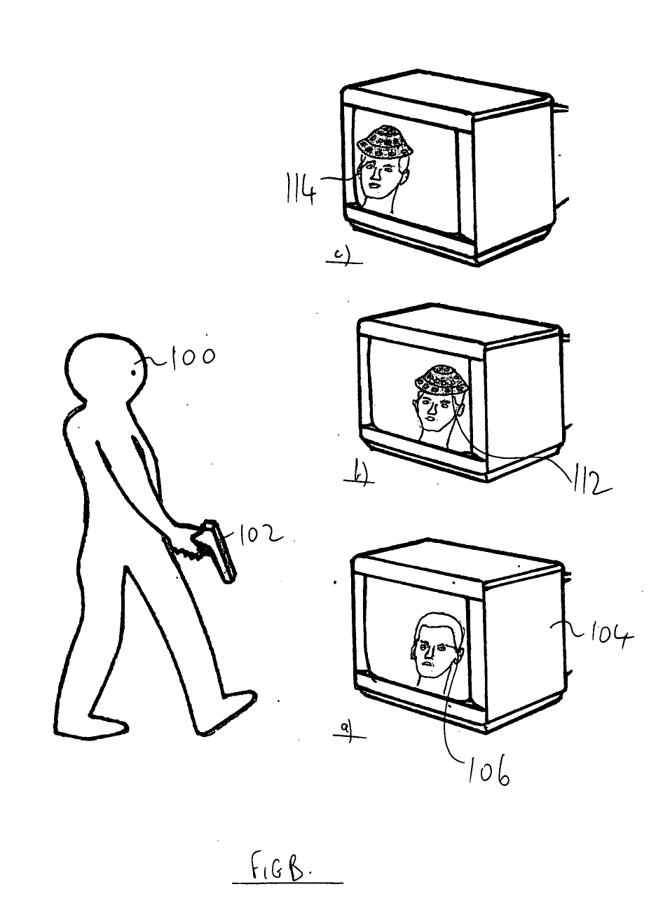

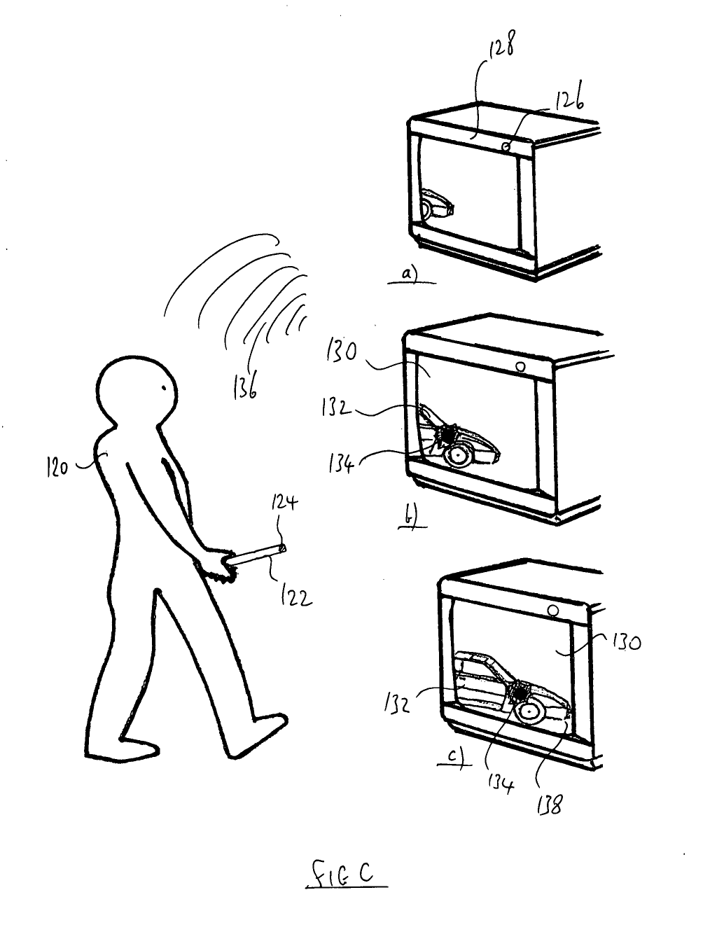

### FIELD OF THE INVENTION

This invention is in the field of television technology and in particular enabling the viewer to physically react to scenes viewed on television by superimposing on the screen a variety of effects.

### BACKGROUND OF THE INVENTION

The trend today is to move away from passive viewing of television by offering to the viewer the option of active participation. This can manifest itself in the form of interactive viewing where the viewer can give his opinion in real-time on a given subject for example, market research. Another use of interactive television viewing can be seen in IL Patent Application No. 173947 made by Yacobi Havosha et al. where many applications of this technology are made including changing the angle of vision of a playing field, identification of players moving on a playing field and real-time gambling during a sports event.

Sometimes viewers want to create effects on the screen that may or may not be connected with the content of the program being shown. The purpose of making such effects could be to express emotions about the subject matter being viewed or for entertainment.

This invention offers the viewer options of creating such effects on the television screen. The basic technology used is known in the art as object recognition and object tracking.

### SUMMARY OF THE INVENTION

It is to be understood that both the foregoing general description and the following detailed description present embodiments of the invention, and are intended to provide an overview, or framework, for understanding the nature and character of the invention as it is claimed. The accompanying drawings are included to provide a further understanding of the invention, and are incorporated into and constitute a part of this specification. The drawings illustrate various embodiments of the invention and, together with the description serve to explain the principles and operations of the invention.

This invention uses a device for example, shaped like a gun, connected with a wire or wirelessly, to a control unit that is connected to a television. If the connotation associated with guns is undesirable, any other instrument could be used as the technology inside the outer casing would be the same. There would however be a need to aim and fire or “send” the instruction from the said instrument to the screen to enable the viewer to have the experience of active participation. The viewer is able to aim the gun at a person or object seen on the television screen and then pull the trigger of the gun. The effect of pulling the trigger could be manifold, according to the viewer's choice. One option could be to make an image on the screen of a hole or a wound on the face or other part of the person or object. The position of the hole or wound would depend on the accuracy of the aiming and shooting. More than one imaginary bullet could be fired. Another option of pulling the trigger could be to add items to people or objects viewed on the screen. Examples of images of items added could be a hat or glasses and the like. Also a naked body image could superimpose on a screened persons body to give the impression of the screened person without clothes.

Another novelty of this invention is that the said effects on screened people, namely bullet holes, clothes and the like will move with the screened person as he moves on the screen. This effect gives the impression that that the viewer has really changed the screened scene. An arrow could be shot at a person on the screen. Its distal feathered end could oscillate as it strikes the person's head and as the hit person moves, the arrow would stay in the same position in the body, reflecting the life-like situation as if the person being filmed really had an arrow in his flesh.

Yet another use of this gun could be to aim at a marked area on the screen which when hit would open a menu offering options like for example, volume control, change of station, on/off switch. The viewer would then shoot at the menu item of his choice.

The application of this invention is not limited to television but can be applied also to video screens and computer screens.

Other effects could be

a) to shoot and give the impression that the television screen broke,
b) instead of the arrow and its oscillating there could be an egg thrown and it could wobble with the movement of the screened person,
c) there could be sound effects when the target is hit,
d) there could be a vibrating effect or a slight electrical shock when the target is hit or alternatively when the target is missed,
e) when the target is hit eye glasses or items of jewelry could be added to the screened image that would, as explained above, move with the screened image as they move on the screen.
f) when a screened image is wounded with a bullet for example, there could be added onto the image of a hole, a plaster or bandage.
g) when a screened person is hit, his voice could be made distorted from then on. The face recognition technology would be used to detect when the hit persons lips are moving and cause his voice to be distorted or muffled.

The technology used in this invention could involve a camera in the gun barrel facing the screen. Alternatively, the camera could be in the television or computer screen that is showing the film or program being viewed. In both cases the camera would identify whether the object being held by a person, whether it be for example, a gun or a plain wooden stick, was pointed in the direction of the object to be hit and the computer program operating this innovation would create the aforementioned effects on that object to be hit.

The technology known as image processing or image analysis is known in the art. This innovation includes the application of this technology as described herein. When the camera is on the television or computer, as opposed to being on the gun or stick, the camera would recognize the gun or stick by its shape or by its color and be able to follow its movements in relation to the objects on the screen.

For example, just a shake of the stick in the direction of a person on the screen could make a mark on the face of the said person. As that person moves on the screen and even if he temporarily left the screen, on his return, the mark could be made to remain on the same position of the said face. The effect is to the viewer as if the person on the screen really has such a mark on his face or whatever other effect is used.

Technology used to identify the position of an object on a screen could be a camera, a laser, infrared, image processing, touch screen and mouse technology. In other words for example, a person could move a mouse cursor on the screen by moving a stick that has been recognized by the camera in a screen and the click of the mouse could be effected by a shake of the stick. This is the same technology used to produce the effects of this innovation.

### BRIEF DESCRIPTION OF THE DRAWINGS

The accompanying drawings, which are incorporated in and form a part of this specification, illustrate embodiments of the invention and, together with the description, serve to explain, by way of example only, the principles of the invention:

FIG. A is a diagram of a person with a gun of this invention and the image of the screened face a) before the shot, b) after a shot and c) after the face has moved on the screen with the shot having moved with the face.

FIG. B is a diagram of a screened image of a person a) without a hat, b) after the button or trigger is pressed having the effect of placing a hat on his head and c) after the person moves to another part of the screen with the hat still on his head.

FIG. C shows the viewer with a stick where the camera is on screen.

### DETAILED DESCRIPTION OF THE PREFERRED EMBODIMENTS

As will be appreciated the present invention is capable of other and different embodiments than those discussed above and described in more detail below, and its several details are capable of modifications in various aspects, all without departing from the spirit of the invention. Accordingly, the drawings and description of the embodiments set forth below are to be regarded as illustrative in nature and not restrictive.

FIG. A is a diagram showing the viewer 100 of a television program. He has an instrument in the shape of a gun with which he aims and “shoots” at the image on the screen 106. Connected to the television 104 is a control unit 105 that enables the “firing” of the gun at an image of a person 106 to have the chosen effect on the screen. The digital program in the control unit 105 also identifies the image and tracks it, thereby enabling the chosen effect to move with the image on the screen.

Assuming the chosen effect is to make an image of a hole in the screened person the when the gun 102 is aimed accurately and fired the viewer will see a hole 108 in the screened person's head.

When the screened person 106 moves on the screen the hole 108 will move with him and give the impression that the hole 108 thereby made is now part of the original filming, even though the viewer 100 caused the hole to appear.

FIG. B is a diagram similar to FIG. A except that it shows an example of adding a hat to the screened person. The viewer 100 aims with the gun 102 at the screened image 106. When he hits the target, virtually, a hat appears on the screened person's head 112. When the image on the television 104 moves, the hat moves with the image 114.

FIG. C shows a viewer 120 with a stick 122 in his hand. The stick 122 could have a color at its tip 124 that could be identified by the camera 126 on the screen frame 128.

As an object 132 moves onto the screen 130 the viewer 120 could point the stick 122 at the object 132 and shake the stick 122. There could appear on the object 132 the appearance of a bullet hole 134 and a sound 136 of a bullet hitting metal.

As the object 132 moves to a new position 138 on the screen 130 the bullet hole image 134 would move with the object 132.

The present invention is not intended to be limited to the embodiments described above, but to encompass any and all embodiments within the scope of the following claims.

What is claimed:

1. A method and device to operate interactive television comprising
a control unit that connects the shooting apparatus to a television,
virtual shooting apparatus,
a means to choose at least one effect to appear on the screen when the said shooting apparatus is fired at an object on the television screen,
a means to make the said chosen effect move with the said object on the said screen,
whereby the viewer can actively cause effects to occur on the television screen and see those effects move with objects on the screen as if they were part of the original recording.

2. A method and device as claimed in claim 1 wherein the said shooting apparatus has the appearance of a gun.

3. A method and device as claimed in claim 1 wherein the said desired effect is to make an image of a bullet hole in the object being shot.

4. A method and device as claimed in claim 1 wherein the desired effect is to add the image of an item to the object being shot.

5. A method and device as claimed in claim 1 wherein the desired effect is a choice of at least one of the image of a broken screen, a raw egg hitting the said object, an arrow hitting the said object, sound effects when an object is hit, different sound effects when an object is missed, a vibrating effect or a slight electric shock in the said shooting apparatus if the object is hit or if it is missed, a plaster or bandage is added over the place where the bullet hits, to paint colors at the place hit and distorted speech by the screened person after he is hit.

6. A method and device as claimed in claim 5 wherein the said egg and said arrow wobble and oscillate respectively with the movement of the object on the screen.

7. A method and device as claimed in claim 5 wherein the choice of effects is made on the shooting apparatus.

8. A method and device as claimed in claim 1 wherein the said television is a video or DVD player with a screen.

9. A method and device as claimed in claim 1 wherein the said television is substituted for a computer and a computer screen.

10. A method and device as claimed in claim 1 wherein the viewer aims at a menu target on the said screen which, when hit, will open a menu of options which, in turn can be operated by the viewer aiming and shooting at the menu item of his desire.

11. A method and device as claimed in claim 1 further comprising a means to load up other said effects from one of a computer memory, the internet and other digital storage means.

12. A method and device to operate interactive television comprising
a) an object with an identifying feature,
b) a camera in a place other than the said object,
c) a means to choose at least one effect to appear on a screen when the said object is moved in front of an image on the television screen,
d) a means to make the said chosen effect move with the said image on the said screen,
whereby the viewer can actively cause effects to occur on the television screen and see those effects move with images on the said screen as if they were part of the original recording.

13. A method and device as claimed in claim 12 wherein the said chosen effect is a choice of at least one of the image of a broken screen, a raw egg hitting the said object, an arrow hitting the said object, sound effects when an object is hit, different sound effects when an object is missed, a vibrating effect or a slight electric shock in the said shooting apparatus if the object is hit or if it is missed, a plaster or bandage is added over the place where the bullet hits, to paint colors at the place hit and distorted speech by the screened person after he is hit.

14. A method and device as claimed in claim 13 wherein the said egg and said arrow wobble and oscillate. respectively with the movement of the object on the screen.

15. A method and device as claimed in claim 13 wherein the said choice of effects is made on the said object.

16. A method and device as claimed in claim 12 wherein the said television is a video or DVD player with a screen.

17. A method and device as claimed in claim 12 wherein the said television is substituted for a computer and a computer screen.

18. A method and device as claimed in claim 12 wherein the viewer aims at a menu target on the said screen which, when the said object is shaken, will open a menu of options which, in turn can be operated by the viewer aiming and shaking at the menu item of his desire.

19. A method and device as claimed in claim 12 further comprising a means to load up other said effects from one of a computer memory, the internet and other digital storage means.
